(19) United States
(12) Patent Application Publication
(10) Pub. No.: US 2004/0194253 A1
(43) Pub. Date: Oct. 7, 2004

(54) Side panel of refrigerator door and coupling structure thereof

(75) Inventor: Jae-Wook Jung, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/800,699

(22) Filed: Mar. 16, 2004

(30) Foreign Application Priority Data
Mar. 19, 2003 (KR) 17080/2003

(51) Int. Cl. E05D 15/00

(52) U.S. Cl. 16/87.2

(57) ABSTRACT

A side panel of a refrigerator door includes a cover part having a side shape of a refrigerator door, an insertion rib formed extended with a certain thickness and height at one marginal portion of the cover part, a hinge insertion part formed at the other side of the cover part and coupled to a hinge coupled to a refrigerator body, and a coupling unit formed at one side of the insertion rib and fixedly coupled by being caught at a front panel of the refrigerator door. In a coupling structure of the side panel, the coupling unit of the side panel is fixedly engaged into a through hole of the front panel. Accordingly, the side panel and the front panel can be coupled firmly and an assembling operation is easy.

### BACKGROUND OF THE INVENTION

1. Field of the Invention

The present invention relates to a refrigerator and, more particularly, to a side panel and its coupling structure capable of facilitating an assembling operation of a refrigerator door and firming a coupling state of the refrigerator door.

2. Description of the Background Art

In general, a refrigerator includes a refrigerating cycle system mounted therein, and cooling air generated from an evaporator constituting the refrigerating cycle system circulatively flows in a freezing chamber and a refrigerating chamber to maintain the freezing chamber and the refrigerating chamber in a cold state. A user preserves food items in the freezing chamber and the refrigerating chamber of the refrigerator.

The refrigerator has various types according to a cooling air circulating method, positions of the freezing chamber and the refrigerating chamber, and the construction of the evaporator.

FIG. 1 is a perspective view of a general refrigerator.

As shown in FIG. 1, the refrigerator includes a refrigerator body 100 having a freezing chamber (not shown) and a refrigerating chamber (not shown), and respective refrigerator doors 200 rotatably mounted at one side of the refrigerator body 100 and opening and closing the freezing chamber and the refrigerating chamber.

The refrigerator body 100 includes a refrigerating cycle system and a cooling air circulation passage for circulating cooling air generated from the refrigerating cycle system in the freezing chamber and the refrigerating chamber.

The refrigerator door 200 has an insulation material embedded therein in order to external transfer of cooling air of the freezing chamber and the refrigerating chamber in a state that the refrigerator door 200 closes the freezing chamber or the refrigerating chamber.

The recent tendency shows that refrigerators are enlarged as a living standard of users is improved, and since the large refrigerators are commonly located in a kitchen or a living room, users increasingly show much attention to the exterior of the refrigerator for a mood of the kitchen or the living room. Thus, the refrigerator door 20 taking the front side of the refrigerator is one of important factors showing the exterior and because it is the most frequently used part, it must be fabricated to be strong and firm. In addition, since the refrigerator door 200 is fabricated separately and then coupled to the refrigerator body 100, and in fabricating the refrigerator door 200, a foaming agent is foamed inside the refrigerator door 200 and then the insulation material is inserted therein, so that a firm assembly structure is required.

With such matters considering, researches are ongoing on the refrigerator door 20 by manufacturers that design and fabricate refrigerators.

FIG. 2 is a partial exploded perspective view of one example of the structure of a refrigerator door under research by the applicant of the present invention.

As shown in FIG. 2, the refrigerator door 200 includes a front panel 210 made from steel plate, a rear panel (internal liner) 220 made of plastic in a certain shape and coupled to the front panel 210 with a certain interval therebetween, an insulation material (not shown) foamed and inserted between the front panel 210 and the rear panel 220, and a side panel 230 coupled to upper and lower ends of the front panel 210 and the rear panel 220.

According to the shape of the front panel 210, the side panel 230 can be coupled to only one side of the refrigerator door 200.

The front panel 210 includes a front surface part 211 formed by a rectangular steel plate, and a rounded side part 212 formed at both sides of the front surface part 211. The upper and lower sides of the front panel 210 has a rectangular shape with one side opened.

The side panel 230 includes a cover part 231 having a certain thickness and area, an insertion rib formed extended at one marginal portion of the cover part 231 and having a certain thickness and height, and a hinge insertion part 232 formed at both sides of the other surface of the cover part 231, respectively.

The cover part 231 has a rectangular shape corresponding to the shape of one side end of the front panel 210 in order to cover the one side end of the front panel 210.

The insertion rib includes a front side rib portion 233 formed at an edge of the front side and both sides of the cover part 231 and inserted into the end portion of the front panel 210, a rear side rib portion 234 formed at an edge of a rear side of the cover part 231, an overlap rib portion 235 formed at both ends of the rear edge of the cover part 231, having a certain length, and distanced from the rear rib portion 234, and an outer side rib portion 236 formed at both ends of the cover part 231 and overlapping with the both sides of the front side rib portion 233 and the overlap rib portion 235.

The overlap rib portion 235 is formed overlapping with the rear side rib portion 234, and an end portion of the rear panel 220 is inserted between the overlap rib portion 235 and the rear side rib portion 234.

An end portion of the front panel 210 is inserted between the outer side rib portion 236 and both side portions of the front side rib portion 233, and the outer side rib portions 236 are placed at both outer sides of the front panel 210.

The hinge insertion part 232 having a certain inner diameter and depth is formed at one side of the cover part 231, which is the opposite to the side where the insertion rib is formed. Thus, the hinge insertion part 232 is protruded with a certain height in an annular-bar form at the side where the insertion rib is formed.

The side panel 230 is coupled to the front panel 210 as follows.

The cover part 231 of the side panel covers the lower end of the front panel 210, and the front side rib portion 233 of the side panel is inserted at the end portion of the front panel 210. Both end portions of the front panel 210 is inserted between the both sides of the front side rib portion 233 and the next-portioned outer side rib portion 236. The outer side rib portion 236 is positioned at both outer sides of the front panel 210.

The side panel 230 can be coupled only to the upper end or only to the lower end of the front panel 210, or both to the upper end and to the lower end of the front panel 210.

The end of the rear panel 220 constituting the refrigerator door 200 is inserted between the overlap rib portion 235 and the rear side rib portion 234 of the side panel 230.

After the rear panel 220 is fixed to the front panel 210 by a tape, a foaming agent is foamed and filled at the inner side formed by the front panel 210, the rear panel 220 and the side panel 230. The foaming agent is coagulated to be an insulation material. A gasket (not shown) is assembled at the edge of the rear panel 220. The gasket prevents leakage of cooling air of the freezing chamber or the refrigerating chamber in a state that the refrigerator door 200 closes the freezing chamber and the refrigerating chamber.

As mentioned above, the refrigerator door 200 is coupled to the refrigerator body 100 as a pair of hinge shafts (not shown) coupled at one side of the refrigerator body 100 are inserted into the hinge insertion portion 232 of the side panel 230.

However, as for the refrigerator door 200, in assembling the side panel 230 and the front panel 210, since the side panel 230 has a certain length, one outer side rib portion 236 is first assembled to the front panel 210 and then the other outer side rib portion 236 is assembled. At this time, the first assembled outer side rib portion 236 may be released, making the assembling operation difficult.

In addition, when the refrigerator door 200 is moved to be coupled to the refrigerator body 100 or when the refrigerator is moved, if an external impact works, the side panel 230 may be released from the front panel 210.

### SUMMARY OF THE INVENTION

Therefore, an object of the present invention is to provide a side panel of a refrigerator door and its coupling structure capable of facilitating an assembling operation of a refrigerator door and making a coupling state of the refrigerator door strong and firm.

To achieve these and other advantages and in accordance with the purpose of the present invention, as embodied and broadly described herein, there is provided a side panel of a refrigerator door including: a cover part having a side shape of a refrigerator door; an insertion rib formed extended with a certain thickness and height at one marginal portion of the cover part; a hinge insertion part formed at the other side of the cover part and coupled to a hinge coupled to a refrigerator body; and a coupling unit formed at one side of the insertion rib and fixedly coupled by being caught at a front panel of the refrigerator door.

To achieve the above object, there is also provided a side panel coupling structure of a refrigerator door including a front panel formed at a front surface of a refrigerator door and having both end portions formed in a bent rectangular form; a side panel coupled to an upper end or a lower end of the front panel; and a rear panel coupled to an inner side of the front panel, wherein through holes are formed at both sides of the front panel, a coupling unit is provided at the side of the side panel, and the coupling unit of the side panel is fixedly coupled into the through holes of the front panel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing one example of a general refrigerator;

FIG. 2 is a partial exploded perspective view showing one example of a refrigerator door in accordance with a conventional art;

FIG. 3 is an exploded perspective view showing a side panel of the refrigerator door and its assembling structure in accordance with the present invention; and

FIG. 4 is an enlarged perspective view showing a coupling unit of the side panel of the refrigerator door in accordance with the present invention.

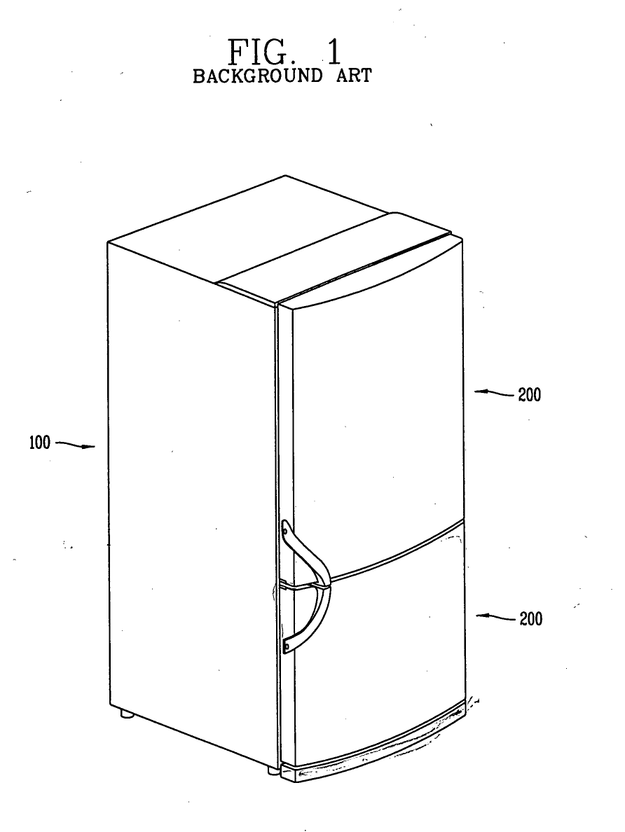

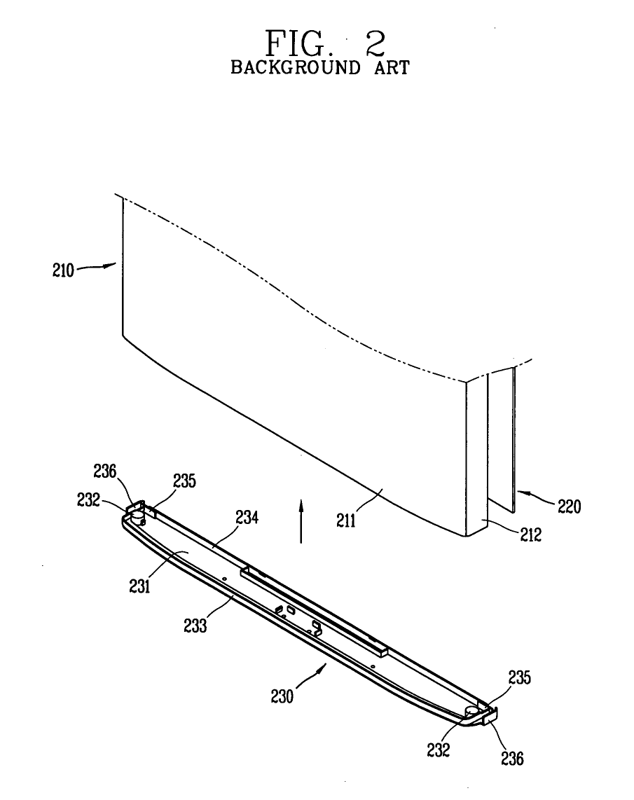

### DETAILED DESCRIPTION OF THE PREFERRED EMBODIMENTS

A side panel of a refrigerator door and its coupling structure in accordance with a preferred embodiment of the present invention will now be described.

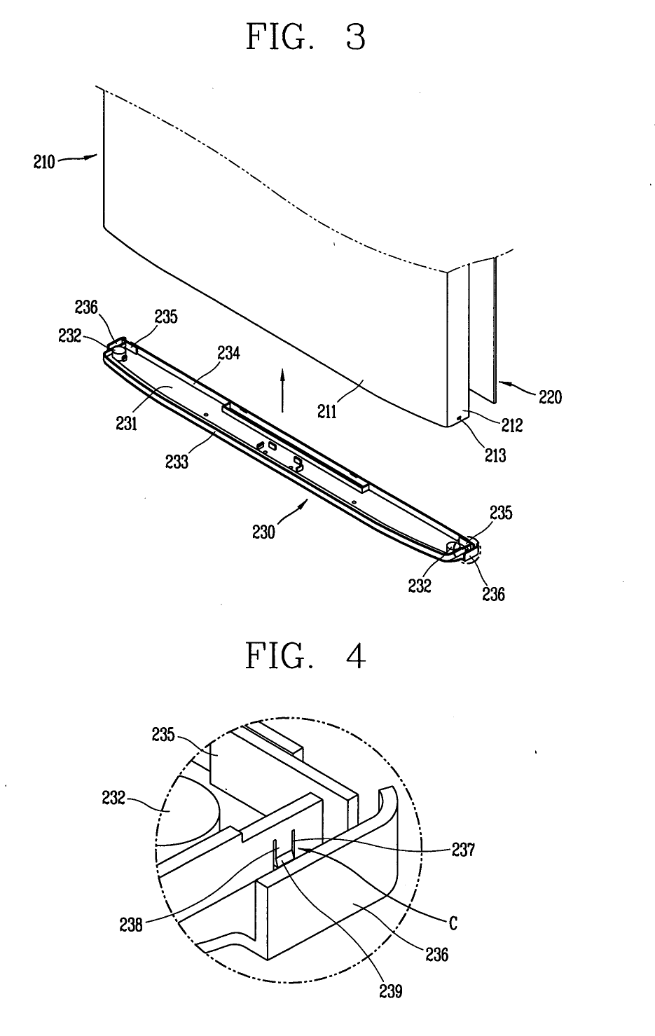

FIG. 3 is an exploded perspective view showing a side panel of the refrigerator door and its assembling structure in accordance with the present invention.

As shown in FIG. 3, the refrigerator door includes a front panel 210 having a rectangular form and made of a steel plate with both end portions bent; a side panel 230 having a coupling unit and coupled to upper and lower ends of the front panel 210; a rear panel 220 (inner liner) coupled to the front panel 210 with a certain interval therebetween; and an insulation material (not shown) foamed and inserted between the front panel 210 and the rear panel 220.

The side panel 230 can be coupled to only one end of the front panel 210 according to the form of the front panel 210. The two side panels 230 respectively coupled to the upper and lower ends of the front panel 210 have the same shape.

The front panel includes a front surface portion 211 formed by a rectangular steel plate; a side surface portion 212 having both sides in rounded form; and through holes 213 formed at upper and lower portions of the side surface portion 212.

The side panel 230 includes a cover part 231 formed corresponding to the side of the front panel 210 and having a certain thickness; an insertion rib formed extended at a marginal portion of one side of the cover part 231 and having a certain thickness and height; a hinge insertion part 232 formed at the other side of the cover part 231 and coupled to a hinge coupled to the refrigerator body 100; and a coupling unit (C) formed at one side of the insertion rib and fixedly coupled by being caught at the front panel 210 of the refrigerator door.

The cover part 231 has a rectangular shape corresponding to the shape of one side end of the front panel 210 in order to cover the one side end of the front panel 210.

The insertion rib includes a front side rib portion 233 formed at an edge of the front side and both sides of the cover part 231 and inserted into the end portion of the front panel 210, a rear side rib portion 234 formed at an edge of a rear side of the cover part 231, an overlap rib portion 235 formed at both ends of the rear edge of the cover part 231, having a certain length, and distanced from the rear rib portion 234, and an outer side rib portion 236 formed at both ends of the cover part 231 and overlapping with the both sides of the front side rib portion 233 and the overlap rib portion 235.

The overlap rib portion 235 is formed overlapping with the rear side rib portion 234, and an end portion of the rear panel 220 is inserted between the overlap rib portion 235 and the rear side rib portion 234.

An end portion of the front panel 210 is inserted between both side portions of the front side rib portion 233 and the outer side rib portion 236, and the outer side rib portion 236 is placed at both outer sides of the front panel 210.

The hinge insertion part 232 is formed at both end portions of the cover part 232 in a longitudinal direction. The hinge insertion portion 232 can be formed only one end portion of the cover part 231 in a longitudinal direction.

The hinge insertion part 232 having a certain inner diameter and depth is formed at one side of the cover part 231, which is the opposite to the side where the insertion rib is formed. Thus, the hinge insertion part 232 is protruded with a certain height in an annular-bar form at the side where the insertion rib is formed.

The coupling unit (C) is provided at both side portions of the insertion rib so as to be positioned at both sides of the front panel 210.

Preferably, the coupling unit (C) is formed at both side portions of the front side rib portion 233 constituting the insertion rib. As shown in FIG. 4, the coupling unit (C) includes a slit 237 having a cantilever form with a certain length; an elastic portion 238 formed inside the slit 237, of which one side fixed, and having a cantilever form with a certain length; and an engaging portion 239 formed extendedly protruded at one side of the elastic portion 238.

The elastic portion 238 has a rectangular form with a certain width and length, one side thereof being connected. The elastic portion 238 has the same longitudinal direction as that of the refrigerator door 200.

The engaging portion 239 has a triangular form in its side section, and a wider portion of the engaging portion is positioned at an end of the elastic portion 238.

The structure of coupling the side panel 230 to the front panel 210 will be described as follows.

The cover part 231 of the side panel covers the lower end of the front panel 210, and the front side rib portion 233 of the side panel is inserted into the front panel 210.

Both end portions of the front panel 210 are inserted between both side portions of the front side rib portion 233 and the next-positioned outer side rib portion 236, and the coupling unit (C) formed at the front side rib portion 233 is insertedly coupled to the through hole 213 of the front panel 210.

In other words, when the end portion of the front panel 210 is inserted between both side portions of the front side rib portion 233 and the outer side rib portion 236, the engaging portion 239 is depressed by the front panel 210, elastically supported by the elastic portion 238 and pushed backward, and then, when the through hole 213 of the front panel 210 and the engaging portion 239 correspond to each other, the engaging portion 239 is inserted into the through hole 213 thanks to the elastic force of the elastic portion 238. The end of the engaging portion 239 is caught by an inner wall of the through hole 213 of the front panel 210, thereby preventing the engaging portion 239 from being released in the opposite direction.

The outer side rib portions 236 are positioned at both outer sides of the front panel 210.

The side panel 230 can be coupled only to the lower end of the front panel 210 or can be coupled both to the upper end and to the lower end of the front panel 210.

The end portion of the rear panel 220 constituting the refrigerator door 200 is inserted between the overlap rib portion 235 and the rear side rib portion 234 of the side panel 230. And then, a foaming agent is foamed and filled at the inner side formed by the front panel 210, the rear panel 220 and the side panel 230. The foaming agent is coagulated to become an insulation material.

A gasket (not shown) is coupled to the rear panel 220 to prevent leakage of cooling air.

As a pair of hinge shafts (not shown) coupled to one side of the refrigerator body 100 is inserted into the hinge insertion part 232 of the side panel 230, the refrigerator door 200 is coupled to the refrigerator body 100. If two hinge insertion parts 232 are provided at the side panel 230, an opening direction of the refrigerator door 200 can be selected.

As so far described, the side panel of the refrigerator door and its coupling structure have many advantages.

That is, for example, first, since the insertion rib is inserted to the end portion of the front panel 210 and the coupling unit (C) of the side panel 230 is fixedly coupled into the through hole 213 of the front panel, the side panel 230 is firmly coupled to the front panel 210 and the exterior view of both ends of the refrigerator door 200 is fine.

In addition, in coupling the side panel 230 to the front panel 210, when the other side of the side panel 230 is coupled to the front panel 210 after one side of the side panel 230 is fixed to the front panel 210, releasing of the fixed opposite side is prevented. Thus, an assembling operation is easy and accordingly assembling productivity can be improved.

Moreover, if an external impact is applied when the refrigerator door 200 is moved to be coupled to the refrigerator body 100 or when the refrigerator is moved, since the side panel 230 is firmly coupled to the front panel 210, the side panel 230 is prevented from being released from the front panel 210. Thus, the refrigerator door 200 or the refrigerator can be freely moved and a reliability can be heightened.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A side panel of a refrigerator door comprising:
a cover part having a side shape of a refrigerator door;
an insertion rib formed extended with a certain thickness and height at one marginal portion of the cover part;
a hinge insertion part formed at the other side of the cover part and coupled to a hinge coupled to a refrigerator body; and
a coupling unit formed at one side of the insertion rib and fixedly coupled by being caught at a front panel of the refrigerator door.

2. The side panel of claim 1, wherein the insertion rib comprises:
a front side rib portion formed at an edge of the front side and both sides of the cover part and inserted into the end portion of the front panel;
a rear side rib portion formed at an edge of a rear side of the cover part;
an overlap rib portion formed at both ends of the rear edge of the cover part, having a certain length, and distanced from the rear rib portion; and
an outer side rib portion formed at both ends of the cover part and overlapping with the both sides of the front side rib portion and the overlap rib portion.

3. The side panel of claim 1, wherein the coupling unit is provided at both side portions of the insertion rib so as to be positioned at both sides of the front panel.

4. The side panel of claim 1, wherein the coupling unit comprises:
a slit having a cantilever form with a certain length formed at one side of the insertion rib;
an elastic portion formed inside the slit, of which one side fixed, and having a cantilever form with a certain length; and
an engaging portion formed extendedly protruded at one side of the elastic portion.

5. The side panel of claim 4, wherein the elastic portion has the same longitudinal direction as that of the refrigerator door.

6. The side panel of claim 4, wherein the engaging portion is formed protruded at an outer side of the insertion rib and the width of an end side of the elastic portion is thicker than an inner side thereof.

7. The side panel of claim 6, wherein the engaging portion has a triangular form in its side section.

8. The side panel of claim 6, wherein a rectangular through hole is formed respectively at both side of the front panel and the coupling unit is fixedly engaged in the through hole of the front panel.

9. The side panel of claim 1, wherein the hinge insertion part is formed at both end portions of the cover part in a longitudinal direction.

10. A side panel coupling structure of a refrigerator door including a front panel formed at a front surface of a refrigerator door and having both end portions formed in a bent rectangular form; a side panel coupled to an upper end or a lower end of the front panel; and a rear panel coupled to an inner side of the front panel,
wherein through holes are formed at both sides of the front panel, a coupling unit is provided at the side of the side panel, and the coupling unit of the side panel is fixedly coupled into the through holes of the front panel.

11. The coupling structure of claim 10, wherein the coupling unit comprises:
a slit having a cantilever form with a certain length formed at one side of the side panel;
an elastic portion formed inside the slit, of which one side fixed, and having a cantilever form with a certain length; and
an engaging portion formed extendedly protruded at one side of the elastic portion.
